(19) United States
(12) Patent Application Publication
(10) Pub. No.: US 2008/0102238 A1
(43) Pub. Date: May 1, 2008

(54) Destructible privacy label

(75) Inventor: John A. Swords, East Lansing, MI (US)

Correspondence Address: Christopher J. Fildes;Fildes & Outland, P.C., Suite 2, 20916 Mack Avenue, Grosse Pointe Woods, MI, 48236, US

(73) Assignee: Tri-State Hospital Supply Corporation

(21) Appl. No.: 11/591,198

(22) Filed: Oct. 31, 2006

(51) Int. Cl. B32B 33/00

(52) U.S. Cl. 428/40.1

(57) ABSTRACT

A destructible privacy label includes a sheet-like member having an upper surface and an adhesive lower surface. The upper surface is capable of displaying information-conveying indicia thereon. The sheet-like member includes two conjoined segments formed by a separation line that traverses the sheet-like member. Each sheet-like member segment is separable from the other along the sheet-like member separation line. A release liner having a tackless upper surface releasably contacts the sheet-like member lower surface. The release liner includes two conjoined segments formed by a separation line. Each release liner segment is separable from the other along the release liner separation line. The separation line of the sheet-like member generally does not overlie the separation line of the release liner.

### TECHNICAL FIELD

This invention relates to labels used in patient health care in connection with medical objects such as medical records, medical containers, and medical devices, and more particularly to privacy labels that are easily destructible to render information on the label illegible in order to insure patient privacy after use.

### BACKGROUND OF THE INVENTION

Health care providers commonly label medical objects such as charts, medical devices, IV bags, and medication containers associated with a particular patient to correlate these objects with the patient and to ensure that the patient receives their intended medical care. However, the Health Insurance Portability and Accountability Act (HIPAA) requires health care providers to hide a patient's identity before disposing of any medical objects associated with the patient.

Patient identification is commonly accomplished by attaching a one-piece label having an adhesive lower surface adapted to adhere to a medical object and an upper surface for displaying information conveying indicia such as a patient's name, social security number, account number, etc. At the conclusion of a medical treatment, for example when a labeled medical container such as an intravenous (IV) bag is emptied, the label must be adequately destroyed to make the information printed thereon illegible. This requires a health care provider to adequately cross out the information printed on the label to protect a patient's identity before disposing of the medical object. Alternatively, a health care provider may attempt to remove the label from the object so the label can be torn into pieces, but removing the label may be difficult depending on how strongly the label has adhered to the object. In any event, destroying the patient identifying information on a label is cumbersome and time consuming.

### SUMMARY OF THE INVENTION

The present invention provides a destructible privacy label for use with patient-associated medical objects such as medical records, medication containers, and medical supplies. The destructible privacy label is easily destroyable prior to disposal of the associated object, thus rendering patient identifying indicia on the label illegible. The privacy label includes two conjoined segments that cooperatively meet along a separation line to form a destructible portion of the label. A user of the label, such as a health care provider, may print patient identifying information on the area of the label within the destructible portion. The privacy label aids a health care provider by allowing the provider to easily destroy the patient information displayed on the label by simply pulling away one of the segments of the label with one hand.

More particularly, a destructible privacy label in accordance with the invention includes a sheet-like member having an upper surface and an adhesive lower surface. The upper surface is capable of displaying information-conveying indicia thereon. The sheet-like member includes two conjoined segments formed by a separation line that traverses the sheet-like member. Each sheet-like member segment is separable from the other along the sheet-like member separation line. A release liner having a tackless upper surface releasably contacts the sheet-like member lower surface. The release liner includes two conjoined segments formed by a separation line. Each release liner segment is separable from the other along the release liner separation line. The separation line of the sheet-like member generally does not overlie the separation line of the release liner.

In a specific embodiment, one of the release liner segments may be larger than the other of the release liner segments. Similarly, one of the sheet-like member segments may be larger than the other of the sheet-like member segments. One of the sheet-like member segments may contact only one of the release liner segments while the other of the sheet-like member segments may contact both release liner segments. In the same manner, one of the release liner segments may contact only one of the sheet-like member segments while the other of the release liner segments may contact both sheet-like member segments.

Optionally, the sheet-like member separation line may be a cut line or a perforated line. Similarly, the release liner separation line may be a cut line or a perforated line. The separation line of the sheet-like member may be at least partially sinusoidal in shape. The separation line of the release liner may be generally a straight line.

The release liner upper surface may be siliconized, or alternatively may be coated with a similar material that renders the upper surface tackless.

In another embodiment of the invention, a destructible privacy label includes a sheet-like member having an upper surface and an adhesive lower surface. The upper surface is capable of displaying information-conveying indicia thereon. The sheet-like member includes two conjoined segments formed by a separation line that traverses the sheet-like member. Each sheet-like member segment is separable from the other along the sheet-like member separation line. An area traversed by the sheet-like member separation line forms a destructible portion of the sheet-like member. A release liner having a tackless upper surface releasably contacts the sheet-like member lower surface. The release liner includes two conjoined segments formed by a separation line. Each release liner segment is separable from the other along the release liner separation line. The destructible portion of the sheet-like member is generally disposed on only one of the release liner segments.

Optionally, the destructible portion of the sheet-like member may comprise less than half of the sheet-like member. The destructible portion may also be disposed proximate a top of the sheet-like member. Further, the separation line of the sheet-like member generally may not overlie the separation line of the release liner. The release liner may generally extend beyond an outer edge of the sheet-like member.

These and other features and advantages of the invention will be more fully understood from the following detailed description of the invention taken together with the accompanying drawings.

### BRIEF DESCRIPTION OF THE DRAWINGS

In the drawings:

FIG. 1 is a perspective view of a destructible privacy label in accordance with the invention;

FIG. 2 is a cross-sectional view of the destructible privacy label taken along the line 2-2 in FIG. 1;

FIG. 3 is an exploded view of the destructible privacy label;

FIG. 4 is an environmental view of a lower side of the destructible privacy label illustrating a user removing a segment of a release liner of the label;

FIG. 5 is another environmental view of the destructible privacy label illustrating the label adhered to an IV bag;

FIG. 6 is another environmental view of the destructible privacy label adhered to an IV bag illustrating a user removing a segment of a sheet-like member of the label; and

FIG. 7 is another environmental view of the destructible privacy label adhered to an IV bag illustrating the label in a destructed state, allowing the IV bag to be discarded without disclosing patient identifying information on the bag.

### DETAILED DESCRIPTION OF THE INVENTION

Referring now to the drawings in detail, numeral 10 generally indicates a destructible privacy label in accordance with the invention. The destructible privacy label 10 allows for easy destruction of patient identifying information printed on a surface of the label prior to disposal of an object to which the label is attached.

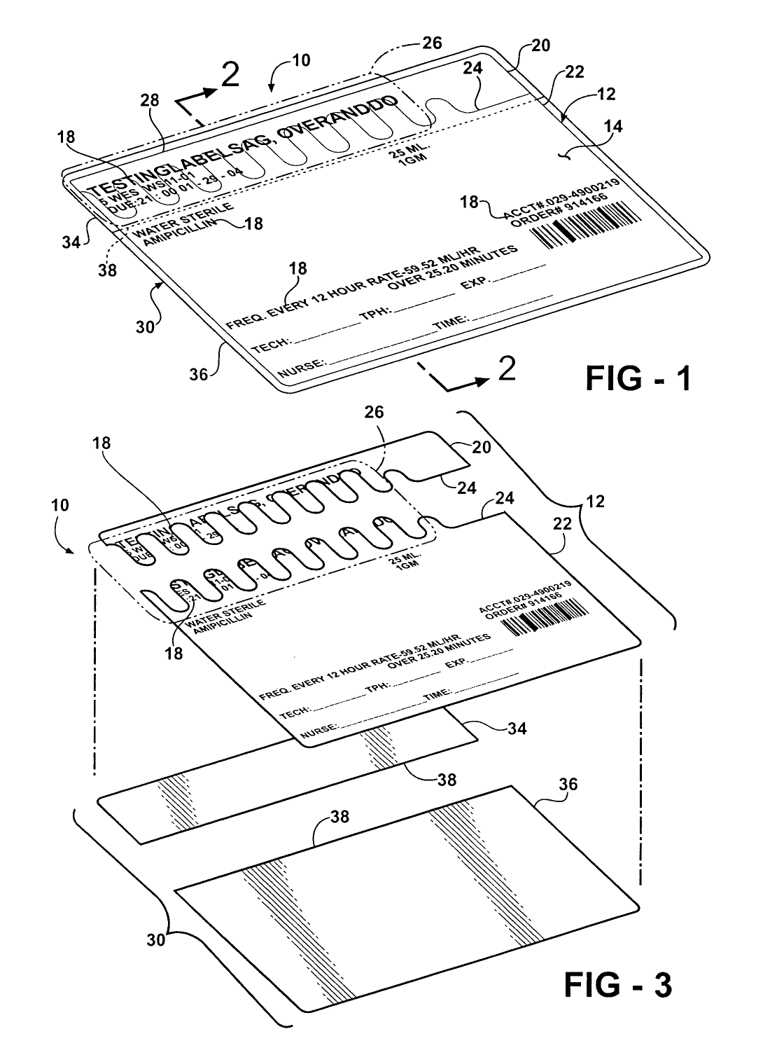

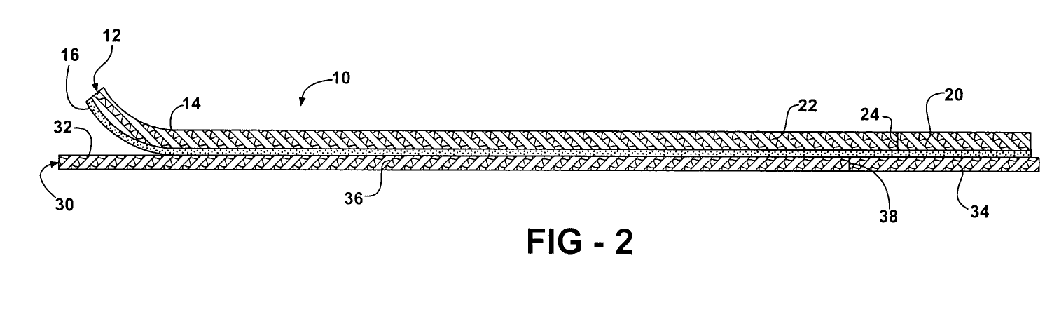

With reference to FIGS. 1 through 3, the destructible privacy label 10 includes a sheet-like member 12 having an upper surface 14 and an adhesive lower surface 16. The adhesive on the adhesive lower surface 16 may be a pressure sensitive adhesive, a permanent adhesive, or any other suitable adhesive for adhering the label 10 to a surface during use. The upper surface 14 is capable of displaying information-conveying indicia 18 thereon (i.e., indicia that conveys information). The information conveyed by the indicia 18 may include a patient's name, a patient's social security number, a patient's account number, patient vital statistics, a bar code, pharmaceutical drug names, drug dosage information, as well as other patient information, words, symbols or alphanumeric text. The indicia 18 preferably may be printed by human or mechanical means. For example, a health care provider may feed the label 10 through a printer connected to a computer to print the indicia 18 on the label. The health care provider may also use a pen or pencil to write information on the label alone or in addition to indicia printed on the label by a printer.

The sheet-like member 12 includes two conjoined segments 20, 22 formed by a separation line 24 that traverses the sheet-like member 12. One of the sheet-like member segments 20, 22 may be larger than the other of the sheet-like member segments, although it is within the scope of the invention for the sheet-like member segments 20, 22 to be the same size. The sheet-like member segments 20, 22 are separable from each other along the sheet-like member separation line 24. The sheet-like member separation line 24 may be a cut line or a perforated line. The separation line 24 may also be a combination of a cut line and a perforated line, wherein groups of perforations are separated from each other along the separation line by cuts. The sheet-like member separation line 24 may be at least partially sinusoidal in shape. In the embodiment shown in FIGS. 1 through 3, the separation line 24 begins on the right-hand side as a straight line but then takes on a sinusoidal shape for a majority of its path across the sheet-like member 12. The separation line 24 may alternatively have at least partially a zig-zag (i.e., sawtooth) shape. The specific shape or pattern of the separation line 24 is not important. It is merely preferable that at least part of the separation line 24 has a back-and-forth, to-and-fro path across the sheet-like member 12. It should be understood, however, that the separation line 24 could be almost entirely or even completely a straight line. An area of the sheet-like member upper surface 14 traversed by the sheet-like member separation line 24 forms a destructible portion 26 of the sheet-like member 12. In other words, the destructible portion 26 is generally an area bounded by the separation line 24. For example, if the separation line 24 is sinusoidal in shape, the destructible portion 26 is bounded on two sides by the nodes of the sinusoidal separation line 24. The shape of the sheet-like member separation line 24 and in turn the amount of area of the sheet-like member 12 that the path of the separation line 24 passes through determines the size of the destructible portion 26. The destructible portion 26 may comprise less than half of the sheet-like member 12. In the embodiment shown in the drawings, the destructible portion 26 comprises approximately 20% of the area of the sheet-like member upper surface 14. It should be understood, however, that the destructible portion 26 is not limited to any particular size. Although shown as a small portion of the sheet-like member 12, the destructible portion 26 may comprise a majority of the sheet-like member 12. The destructible portion 26 may be disposed proximate a top of the sheet-like member 12 as shown by example in the drawings. It is preferable for the destructible portion 26 to be disposed adjacent to or proximate an outer edge 28 of the sheet-like member 12 as discussed in more detail below. The specific disposition of the destructible portion 26 on the label 12, however, is not fixed to any particular location.

A release liner 30 having a tackless upper surface 32 releasably contacts the sheet-like member adhesive lower surface 16. The release liner upper surface 32 may be siliconized (i.e., may have a layer of silicone material thereon). Alternatively, the release liner upper surface 32 may be coated with a material similar to a silicone material that renders the upper surface tackless. By having a tackless upper surface 32, the release liner 30 is easily separable from the sheet-like member 12 when it is desired to separate the two. The sheet-like member 12, however, has sufficient adhesion to the release liner 30 that the two remain in contact until a user deliberately applies a pulling force to one or the other.

The release liner 30 includes two conjoined segments 34, 36 formed by a separation line 38. One of the release liner segments 34, 36 may be larger in size than the other of the segments, although it is also within the scope of the invention for the release liner segments 34, 36 to be the same size. The relative size of the release liner segments 34, 36 depends in part on the size and location of the destructible portion 26, which will become more apparent from the discussion below. The release liner segments 34, 36 are separable from each other along the release liner separation line 38. The release liner separation line 38 may be a cut line or a perforated line, or may be a combination of a cut line and a perforated line. The release liner separation line 38 may also be generally a straight line, although the separation line 38 need not have any particular shape and is not limited to a straight line.

The separation line 24 of the sheet-like member 12 generally does not overlie the separation line 38 of the release liner 30. In other words, the separation line 24 in the sheet-like member 12 layer does not lie over or upon the separation line 38 of the release liner 30 layer, which is below the sheet-like member 12 layer. Also, if the separation lines 24, 38 were considered to lie in a single plane, the separation lines would generally not intersect. Due to the relative locations of the separation lines 24, 38, the destructible portion 26 of the sheet-like member 12 is generally disposed on one of the release liner segments, for example, as shown in the drawings, on release liner segment 34. It is possible for a small part of the destructible portion 26 to overlap the other release liner segment 36. It is preferable, however, for the destructible portion 26 to be almost completely or entirely disposed on only one release liner segment. Furthermore, sheet-like member segment 20 may contact only release liner segment 34 while sheet-like member segment 22 may contact both release liner segments 34, 36. Similarly, release liner segment 36 may contact only sheet-like member segment 22 while release liner segment 34 may contact both sheet-like member segments 20, 22.

The release liner 30 may generally extend beyond the outer edge 28 of the sheet-like member 12. This allows for easier separation of the sheet-like member 12 from the release liner 30. The outer periphery of the release liner 30 in effect can function as a pull tab.

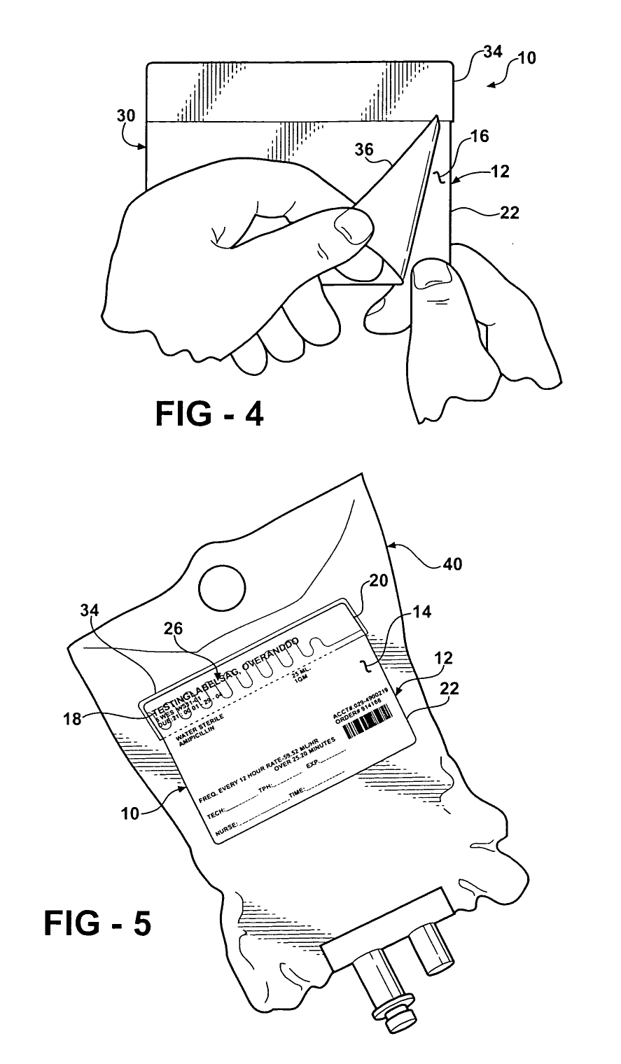

Turning now to FIGS. 4 through 7, someone such as a health care provider may use the destructible privacy label 10 to display patient information and related medical information which later may need to be destroyed prior to disposal of the label. As shown in FIG. 4, in order to apply the label 10 to an object such as an IV bag 40, a user first removes only one of the release liner segments, namely release liner segment 36. More specifically, the user removes the release liner segment that only contacts one of the sheet-like member segments (segment 22 in the illustrated embodiment) and that further does not contact the destructible portion 26 of the sheet-like member 12. Information-conveying indicia 18 may be printed on the sheet-like member upper surface 14 prior to removal of release liner segment 36. For example, if the label 10 is to be run through a printer, it is highly preferable to conduct this step while the release liner 30 remains in contact with the sheet-like member 12. It is also possible for a user to hand print information on the sheet-like member upper surface 14 before removal of release liner segment 36 or after the label 10 is applied to an object.

After removal of release liner segment 36, the user may apply the label 10 to an object such as the IV bag 40 by pressing the exposed adhesive lower surface 16 against the IV bag 40. This step is preferably conducted soon after removal of the release liner segment 36. Otherwise, the sheet-like member 12 may become inadvertently stuck to another object. In FIG. 5, the label 10 is shown affixed to the IV bag 40. Placing the label 10 on an object such as the IV bag 40 associates the object with a patient's identity and personal information represented by the indicia 18 on the sheet-like member upper surface 14. When the label 10 is applied to the IV bag 40, sheet-like member segment 20 does not become stuck to the IV bag 40 because release liner segment 34 remains in contact with the adhesive lower surface 16 of sheet-like member segment 20. The destructible portion 26 of the label 10 also does not become stuck to the IV bag 40. The destructible portion 26 and the release liner segment 34 form a tab. In the embodiment shown in the drawings, the tab is generally at the top of the label 10. Depending upon the location of the destructible portion 26, the tab alternatively could be disposed on the left side, right side, or bottom of the label.

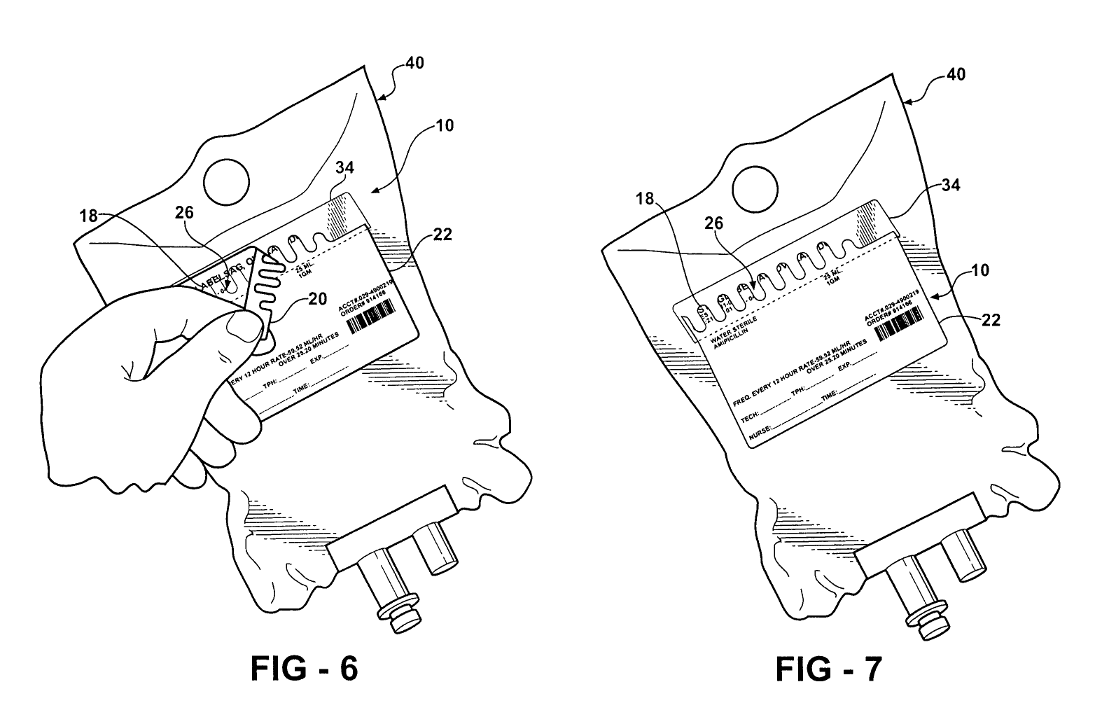

When the IV bag 40 is finished being used (e.g., when it is empty), or at any time when an object associated with the label 10 is ready for disposal, the patient information displayed in the destructible portion 26 can be shredded. As shown in FIG. 6, to destroy the information displayed in the destructible portion 26, the user grasps the sheet-like member segment that generally only contacts one of the release liner segments, namely sheet-like member segment 20 contacting release liner segment 34. The user then pulls the sheet-like member segment 20 away from the release liner segment 34 and sheet-like member segment 22. Because the sheet-like member segment 20 is in contact with the release liner segment 34 and is not adhered to the IV bag 40, the sheet-like member segment 20 is easily removable. If sheet-like member segment 20 were adhered to the IV bag 40, it would be difficult to remove. On the other hand, sheet-like member segment 22 is adhered to the IV bag 40 and remains in place. Also, release liner segment 34 remains in place because it is still partially in contact with the adhesive lower surface 16 of sheet-like member segment 22. The sheet-like member segment 20, once removed, may be discarded into a wastebasket or other trash receptacle.

It is alternatively possible to remove sheet-like member segment 20 as well as release liner segment 34, leaving only sheet-like member segment 22 adhered to the IV bag 40. The important feature is that sheet-like member segment 20 is separated from and disposed of separately from sheet-like member segment 22.

As illustrated in FIG. 7, removing sheet-like member segment 20 renders the information printed in the destructible portion 26 illegible. This effectively protects the privacy of the patient's identity and other personal information that is printed in the destructible portion 26. At this time, the IV bag 40 may also be discarded. Since the patient information remaining on the sheet-like member segment 22 in the destructible portion 26 is illegible, anyone who later may come in contact with the IV bag 40 will not be able to associate the IV bag 40 with the patient. Hence, the patient's identity and personal health information are protected.

Although the invention has been described by reference to a specific embodiment, it should be understood that numerous changes may be made within the spirit and scope of the inventive concepts described. Accordingly, it is intended that the invention not be limited to the described embodiment, but that it have the full scope defined by the language of the following claims.

What is claimed is:

1. A destructible privacy label comprising:
a sheet-like member having an upper surface and an adhesive lower surface, said upper surface being capable of displaying information-conveying indicia thereon;
said sheet-like member including two conjoined segments formed by a separation line that traverses said sheet-like member;
each sheet-like member segment being separable from the other along the sheet-like member separation line; and
a release liner having a tackless upper surface releasably contacting said sheet-like member lower surface;
said release liner including two conjoined segments formed by a separation line, each release liner segment being separable from the other along the release liner separation line;
wherein the separation line of said sheet-like member generally does not overlie the separation line of said release liner.

2. The destructible privacy label of claim 1, wherein said sheet-like member separation line is one of a cut line and a perforated line.

3. The destructible privacy label of claim 1, wherein said release liner separation line is one of a cut line and a perforated line.

4. The destructible privacy label of claim 1, wherein said release liner upper surface is siliconized.

5. The destructible privacy label of claim 1, wherein one of said release liner segments is larger than the other of said release liner segments.

6. The destructible privacy label of claim 1, wherein one of said sheet-like member segments is larger than the other of said sheet-like member segments.

7. The destructible privacy label of claim 1, wherein one of said sheet-like member segments contacts only one of said release liner segments while the other of said sheet-like member segments contacts both release liner segments, and one of said release liner segments contacts only one of said sheet-like member segments while the other of said release liner segments contacts both sheet-like member segments.

8. The destructible privacy label of claim 1, wherein the separation line of said sheet-like member is at least partially sinusoidal in shape.

9. The destructible privacy label of claim 1, wherein the separation line of said release liner is generally a straight line.

10. A destructible privacy label comprising:
a sheet-like member having an upper surface and an adhesive lower surface, said upper surface being capable of displaying information-conveying indicia thereon;
said sheet-like member including two conjoined segments formed by a separation line that traverses said sheet-like member;
each sheet-like member segment being separable from the other along the sheet-like member separation line;
an area traversed by said sheet-like member separation line forming a destructible portion of said sheet-like member; and
a release liner having a tackless upper surface releasably contacting said sheet-like member lower surface;
said release liner including two conjoined segments formed by a separation line, each release liner segment being separable from the other along the release liner separation line;
wherein said destructible portion of said sheet-like member is generally disposed on only one of said release liner segments.

11. The destructible privacy label of claim 10, wherein said destructible portion of said sheet-like member comprises less than half of the sheet-like member.

12. The destructible privacy label of claim 10, wherein said destructible portion is disposed proximate a top of said sheet-like member.

13. The destructible privacy label of claim 10, wherein the separation line of said sheet-like member generally does not overlie the separation line of said release liner.

14. The destructible privacy label of claim 10, wherein said release liner generally extends beyond an outer edge of said sheet-like member.
